(19) United States
(12) Patent Application Publication
(10) Pub. No.: US 2014/0032024 A1
(43) Pub. Date: Jan. 30, 2014

(54) METHOD FOR OPERATING A HYBRID VEHICLE

(71) Applicant: MAGNA STEYR Engineering AG & Co KG, Graz (AT)

(72) Inventors: Christian PONGRATZ, St. Peter am Ottersbach (AT); Markus PASSATH, Gleisdorf (AT); Manfred POSCH, Graz (AT)

(21) Appl. No.: 13/937,250

(22) Filed: Jul. 9, 2013

(30) Foreign Application Priority Data
Jul. 24, 2012 (EP) 12177683.5

(51) Int. Cl. B60W 20/00

(52) U.S. Cl. CPC B60W 20/40; Y10S 903/903
USPC 701/22; 180/65.28; 903/903

(57) ABSTRACT

A method for operating a hybrid vehicle having an internal combustion engine, an electrical machine, an electrical storage device and a control system. The method includes determining a power currently available of the electrical storage device by the control system when a current state of charge of the electrical storage device is less than a charge threshold value; activating the internal combustion engine when the determined power currently available from the electrical storage device exceeds a first power threshold; and determining the power currently available from the electrical storage device by the control system when the determined power currently available from the electrical storage device is less than the first power threshold.

### CROSS-REFERENCE TO RELATED APPLICATIONS

The present application claims priority under 35 U.S.C. §119 to European Patent Application No. EP 12177683.5 (filed on (Jul. 24, 2012), which is hereby incorporated by reference in its entirety.

### TECHNICAL FIELD

A method for operating a hybrid vehicle that has an internal combustion engine, an electrical machine, an electrical storage device and a control system.

### BACKGROUND

A hybrid vehicle having an internal combustion engine and at least one electrical machine is known. The electrical machine can thereby be configured as the primary drive machine and the internal combustion engine can be, for example, activated as required in order to charge up the electrical storage device and/or to directly provide additional drive energy.

For such a hybrid vehicle, an operating method is also known that calculates an optimal activation/starting point in time for the internal combustion engine and are thereby intended in particular to enable travel for as long as possible with purely electrical drive. For this purpose, data from navigation equipment are also often evaluated in order to take into account the expected route.

A method is known from DE 10 2010 025 335 A1 for controlling a hybrid motor vehicle having an electric motor drive unit powered from an electric accumulator and an internal combustion engine effectively connected to a generator for charging the accumulator and a control unit for controlling the drive unit. The internal combustion engine is controlled at least depending on one of the following parameters: (i) a demanded continuous power of the accumulator, (ii) a temperature of the accumulator, (iii) vibrations occurring in the motor vehicle, and (iv) a downtime of the internal combustion engine.

The known operating method is undesirable due to the fact that the activation/starting time for the internal combustion engine is often calculated in a complex manner.

### SUMMARY

Embodiments are directed to a method for operating a hybrid vehicle that enables good utilization of the battery capacity in a simple manner.

Embodiments are directed to a method for operating a hybrid vehicle that enhances the ride comfort when activating the internal combustion engine.

In accordance with embodiments, a method for operating a hybrid vehicle that comprises an internal combustion engine, an electrical machine, an electrical storage device and a control system, the method including at least one of the following: determining a first currently available power in the electrical storage device by the control system on fulfillment of a first starting condition; activating/starting the internal combustion engine if the determined currently available power from the electrical storage device is greater than a first power threshold; and continuously determining the currently available power in the electrical storage device by the control system if the determined currently available power from the electrical storage device is less than the first power threshold.

In accordance with embodiments, a request to activate/start the internal combustion engine based on the fulfillment of a first activation/starting condition is not done instantaneously after the request. Instead, a determination is subsequently made as to whether the necessary power for activation/starting the internal combustion engine is also available in the electrical storage device, taking into account the power currently drawn by electric loads such as the electrical machine. Such a determination may occur one or more times until the available power from the electrical storage device is greater than the power threshold.

In a method for operating a hybrid vehicle having an internal combustion engine, an electrical storage device and a control system includes at least one of: determining a power currently available of the electrical storage device by the control system on fulfillment of a first activation condition of the internal combustion engine; activating the internal combustion engine when the determined power currently available from the electrical storage device exceeds a first power threshold; and determining the power currently available from the electrical storage device by the control system when the determined power currently available from the electrical storage device is less than the first power threshold.

In a method for operating a hybrid vehicle having an internal combustion engine and an electrical storage device includes at least one of: determining a power currently available of the electrical storage device when a current state of charge of the electrical storage device is less than a charge threshold value; and activating the internal combustion engine when the determined power currently available from the electrical storage device exceeds a first power threshold.

In a method for operating a hybrid vehicle includes at least one of: determining a power currently available of an electrical storage device of the hybrid vehicle when a current state of charge of the electrical storage device is less than a charge threshold value; activating an internal combustion engine of the hybrid vehicle when the determined power currently available from the electrical storage device exceeds a first power threshold; determining the power currently available from the electrical storage device when the determined power currently available from the electrical storage device is less than the first power threshold; and determining whether a predetermined maximum time period is exceeded when the determined power currently available from the electrical storage device is less than the first power threshold,

wherein determining the power currently available from the electrical storage device when the determined power currently available from the electrical storage device is less than the first power threshold is repeated until either the internal combustion engine is activated or the maximum waiting period is exceeded

In a case in which the necessary power is available after the determination, the internal combustion engine is activated/started and the activating/starting request is hereby fulfilled. If, however, the available power resources of the electrical storage device are not sufficient, the power consumption of the load is not immediately limited in order to make the power for activation/starting the internal combustion engine available, because the ride comfort would be adversely affected by, for example, a reduction in the current electrical drive power. Therefore, an additional determination is made as to whether the required power has not already been fulfilled at a slightly later point in time, because in many driving situations the required electrical drive energy is lower at a slightly later time, and hence, an only slightly delayed start of the internal combustion engine is enabled without adversely affecting the fulfillment of the current drive requirements.

In accordance with embodiments, the continuous determination of the power currently available from the electrical storage device and checking whether the power currently available from the electrical storage device is above the first power threshold is advantageously carried out by a real time control system in a real time loop.

The activation/starting condition is advantageously selected so that there is still sufficient assurance that the vehicle can continue to be operated purely electrically for a sufficiently long period and that the internal combustion engine can then always still be started.

In accordance with embodiments, the first activation/starting condition is fulfilled when the current state of charge of the electrical storage device is less than a charge threshold value. The state of charge of the electrical storage device is used as the activation/starting condition and the charge threshold value below which activation/starting the internal combustion engine is requested is preferably specified so that at said charge threshold value the electrical storage device still has sufficient capacity to enable electrical driving for a specified time, for example, a few minutes, and subsequent activation/starting of the internal combustion engine.

In accordance with embodiments, the power currently available from the electrical storage device is determined depending on the current load power with which the electrical storage device is being loaded by all loads. In this way the present power consumption by all loads, such as, for example, by the electrical machine for driving the vehicle, is taken into account in the determination of the available power.

In accordance with embodiments, the power currently available from the electrical storage device is advantageously determined as the difference between the maximum power output (state of power) of the electrical storage device and the present load power with which the electrical storage device is loaded by all loads. The maximum power output of the electrical storage device (state of power) is normally determined continuously by battery controllers.

In accordance with embodiments, the first power threshold is determined by multiplying a power required for activation/starting the internal combustion engine and a first safety factor. The power threshold value above which the internal combustion engine is started immediately is thus selected so that the previously determined power that is necessary for activation/starting the internal combustion engine is still multiplied by a specified safety factor, normally greater than one. This advantageously ensures that the available power is sufficient for the entire activation/starting process of the internal combustion engine.

In accordance with embodiments, the sequence whereby a power currently available from the electrical storage device is determined and if the power currently available from the electrical storage device exceeds a first power threshold the internal combustion engine is started, and if the power currently available from the electrical storage device is less than the first power threshold the power currently available from the electrical storage device is determined again, is repeated as often as necessary until either the internal combustion engine is started or a maximum waiting period is exceeded.

In accordance with embodiments, a determination may be done continuously as to whether the power required to start the internal combustion engine is also available, and which in the determination is negative, the current loads are still not yet reduced in power but the wait for sufficient power is continued.

In accordance with embodiments, after reaching a specified maximum waiting time period, the waiting cannot be continued because otherwise the capability to start the internal combustion engine is no longer assured. The maximum waiting period can advantageously be a few minutes, for example, approximately 2 minutes, or 5 minutes, or 10 minutes.

In accordance with embodiments, if the maximum waiting period is exceeded, that the current load power with which the electrical storage device is loaded by all loads is reduced until the power currently available from the electrical storage device exceeds the first power threshold, whereupon the internal combustion engine is started.

The reduction of the load power preferably takes place slowly, for instance, at a maximum of 3 kW per second. This advantageously prevents an abrupt change in the behaviour of the vehicle, especially an abrupt drop in the current drive power.

In accordance with embodiments, the maximum load power is limited with which the electrical storage device is loaded by all loads to a second power threshold while the internal combustion engine is being activated/started. After the decision to actually activate/start the internal combustion engine has been taken by the controller of the vehicle and the activation/starting process has been set in progress, this ensures that even during the activation/starting phase of the internal combustion engine the other loads do not consume so much power from the electrical storage device that the activation/starting process is placed at risk.

In accordance with embodiments, the second power threshold is determined similarly to the first power threshold, namely by multiplying the power required for activating/starting the internal combustion engine and a second safety factor. The second safety factor may be different value than the first safety factor. The second safety factor may be a value of one, because during the activation/starting phase a lower power reserve is necessary than before activating/starting the internal combustion engine.

In accordance with embodiments, the limitation of the maximum load power is slowly withdrawn after activating/starting the internal combustion engine. In particular, the withdrawal of the limitation may occur in the form of a ramp function, i.e., progressively. Advantageously, in this way, an abrupt power increase of the load, and especially of the electrical drive, is prevented.

In accordance with embodiments, when the internal combustion engine is activated/started, it is accelerated to at least 1000 rpm, or at least 1500 rpm. Running up the internal combustion engine to high revolution rates advantageously causes enhanced activation/starting acoustics and enables a reduction of emissions by the internal combustion engine.

### DRAWINGS

Embodiments are described by way of example below with reference to the drawing.

FIG. 1 illustrates a schematic flow diagram of a method in accordance with embodiments.

### DESCRIPTION

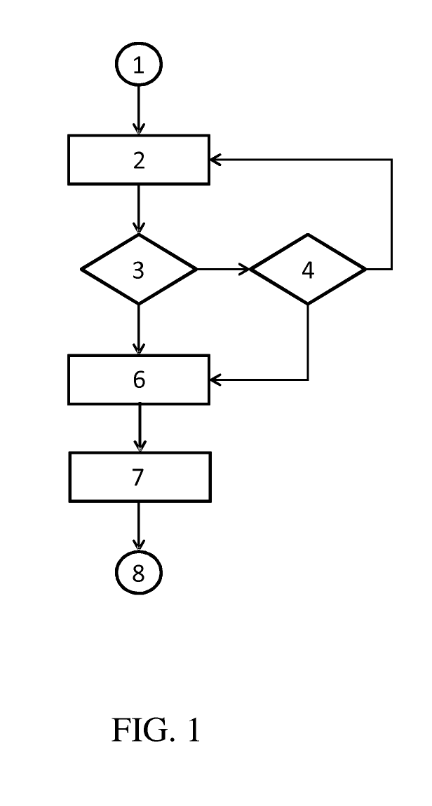

As illustrated in FIG. 1, a method for operating a hybrid vehicle in accordance with embodiments is provided. The process of the method is set progressively by detecting the fulfillment of a first activation/starting condition (1) by a control system, which for example, may be a high level control system, and, if necessary, sending an electric signal to the control system for implementing the method in accordance with embodiments. The fulfilled activation/starting condition can occur in that the current state of charge of the electrical storage device of the hybrid vehicle has fallen below or is otherwise a value which is less than a specified or predetermined charge threshold value. From this the control system determines (2) the power currently available from the electrical storage device by subtracting the current power consumed by all loads from the current maximum available power of the storage device, i.e., the current potential power output.

A determination (3) is then carried out as to whether the power currently available from the electrical storage device is greater than a first power threshold, which is essentially defined by the power required for activating/starting the internal combustion engine, which can be increased by a safety factor value.

If the determination (3) is conclusive that the available power is sufficient for activating/starting the internal combustion engine, i.e., the power currently available from the electrical storage device is greater than the first power threshold, the internal combustion engine is thereupon activated/started (6). When activating/starting the internal combustion engine, the maximum power of the remaining loads is limited so that the power necessary for the entire activation/starting process of the internal combustion engine may be reliably provided by the electrical storage device. Only at the end (7) of the activation/starting process of the internal combustion engine is the power limiting of the remaining loads slowly withdrawn again. The method then concludes (8).

If the determination (3) reveals that the electrical storage device cannot currently provide the required power for activation/starting the internal combustion engine, i.e., the power currently available from the electrical storage device is less than the first power threshold, then a determination (4) is also conducted as to whether a predetermined maximum waiting period has already been exceeded. Alternatively, of course, the determination (4) may be conducted prior to the determination (3). Meaning, the determination (4) is made as to whether the maximum waiting period has already been exceeded (4) and only after in a case in which the maximum waiting period has not yet been exceeded, the determination (3) is made as to whether the currently available power of the electrical storage device exceeds the first power threshold, and thus, is thus sufficient for activating/starting the internal combustion engine.

In accordance with embodiments, if the determination (3) that the currently available power of the electrical storage device is not sufficient and the determination (4) that the maximum waiting time has not been exceeded, then a determination (2) of the currently available power from the electrical storage device is determined again and compared with the required power in order to determine whether at a later point in time the currently available power of the electrical storage device is sufficient for activating/starting the internal combustion engine.

In accordance with embodiments, the determination (4) of whether the maximum waiting period has already been exceeded may be optionally conducted within the cycle of events of determination (2) of the power currently available and the determination (3) of whether the currently available power exceeds the first power threshold, i.e., even after the determination (2) of the power currently available from the electrical storage device and prior in time to determining (3) whether the power currently available is greater than the first power threshold.

In accordance with embodiments, a method provides a simple manner in which to operate a hybrid vehicle, and enables good utilization of the battery capacity and enhances the ride comfort when activating/starting the internal combustion engine.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### LIST OF REFERENCE SIGNS

1 Fulfilling a first activation/starting condition
2 Determining the power currently available from the electrical storage device
3 Determining whether the power currently available from the electrical storage device is greater than a first power threshold
4 Determining whether the maximum waiting period was exceeded
6 Activating/starting the internal combustion engine
7 Ending the activation/starting of the internal combustion engine
8 End

What is claimed is:

1. A method for operating a hybrid vehicle, comprising:
determining a power currently available of an electrical storage device of the hybrid vehicle by a control system of the hybrid vehicle on fulfillment of a first activation condition of an internal combustion engine of the hybrid vehicle;
activating the internal combustion engine when the determined power currently available from the electrical storage device exceeds a first power threshold; and
determining the power currently available from the electrical storage device by the control system when the determined power currently available from the electrical storage device is less than the first power threshold.

2. The method of claim 1, wherein a first activation of the internal combustion engine condition is fulfilled when a current state of charge of the electrical storage device is less than a charge threshold value.

3. The method of claim 1, wherein the power currently available from the electrical storage device is determined depending on a current load power with which the electrical storage device is loaded by all loads.

4. The method of claim 3, wherein the power currently available from the electrical storage device is determined as a difference between a maximum power output of the electrical storage device and the current load power, with which the electrical storage device is loaded by all loads.

5. The method of claim 1, wherein the first power threshold is determined by multiplying a power required to activate the internal combustion engine and a first safety factor.

6. The method of claim 1, wherein determining the power currently available from the electrical storage device by the control system when the determined power currently available from the electrical storage device is less than the first power threshold is repeated until either the internal combustion engine is activated or a maximum waiting period is exceeded.

7. The method of claim 6, wherein if the maximum waiting period is exceeded, a current load power with which the electrical storage device is loaded by all loads is reduced until the power currently available from the electrical storage device exceeds the first power threshold, whereupon the internal combustion engine is activated.

8. The method of claim 7, wherein the reduction of the load power is a maximum of 3 kW per second.

9. The method of claim 1, wherein while the internal combustion engine is activated, a maximum load power with which the electrical storage device is loaded by all loads is limited to a second power threshold.

10. The method of claim 9, wherein the second power threshold is determined by multiplying the power required to activate the internal combustion engine and a second safety factor.

11. The method of claim 9, wherein a limitation of the maximum load power is withdrawn after activating the internal combustion engine.

12. The method of claim 1, wherein activating the internal combustion engine comprises accelerating the internal combustion engine to at least 1000 rpm.

13. The method of claim 1, wherein activating the internal combustion engine comprises accelerating the internal combustion engine to at least 1500 rpm.

14. A method for operating a hybrid vehicle, comprising:
determining a power currently available of an electrical storage device of the hybrid vehicle when a current state of charge of the electrical storage device is less than a charge threshold value; and
activating an internal combustion engine of the hybrid vehicle when the determined power currently available from the electrical storage device exceeds a first power threshold.

15. The method of claim 14, further comprising determining the power currently available from the electrical storage device when the determined power currently available from the electrical storage device is less than the first power threshold.

16. The method of claim 15, wherein determining the power currently available from the electrical storage device is dependent upon a current load power with which the electrical storage device is loaded by all loads.

17. The method of claim 15, wherein determining the power currently available from the electrical storage device comprises determining a difference between a maximum power output of the electrical storage device and the current load power with which the electrical storage device is loaded by all loads.

18. The method of claim 14, wherein the first power threshold is determined by multiplying a power required to activate the internal combustion engine and a first safety factor.

19. The method of claim 19, wherein while the internal combustion engine is activated, a maximum load power with which the electrical storage device is loaded by all loads is limited to a second power threshold determined by multiplying the power required to activate the internal combustion engine and a second safety factor.

20. A method for operating a hybrid vehicle, comprising:
determining a power currently available of an electrical storage device of the hybrid vehicle when a current state of charge of the electrical storage device is less than a charge threshold value;
activating an internal combustion engine of the hybrid vehicle when the determined power currently available from the electrical storage device exceeds a first power threshold;
determining the power currently available from the electrical storage device when the determined power currently available from the electrical storage device is less than the first power threshold; and
determining whether a predetermined maximum time period is exceeded when the determined power currently available from the electrical storage device is less than the first power threshold,
wherein determining the power currently available from the electrical storage device when the determined power currently available from the electrical storage device is less than the first power threshold is repeated until either the internal combustion engine is activated or the maximum waiting period is exceeded.
